(19) United States
(12) Patent Application Publication
(10) Pub. No.: US 2025/0340365 A1
(43) Pub. Date: Nov. 6, 2025

(54) CART RECOGNITION TO PREDICT POWER DEMAND

(71) Applicant: Oshkosh Corporation, Oshkosh, WI (US)

(72) Inventor: Steve Wagester, Oshkosh, WI (US)

(73) Assignee: Oshkosh Corporation, Oshkosh, WI (US)

(21) Appl. No.: 19/197,895

(22) Filed: May 2, 2025

Related U.S. Application Data
(60) Provisional application No. 63/642,072, filed on May 3, 2024.

(51) Int. Cl. B65F 3/04; B65F 3/02

(52) U.S. Cl. CPC B65F 3/04; B65F 2003/0283

(57) ABSTRACT

A refuse vehicle is disclosed, comprising an auxiliary component, a sensor, and processing circuitry with one or more processors and non-transitory, computer-readable media. The processing circuitry is configured to obtain a dataset from the sensor containing a primary attribute, detect an object for collection based on the primary attribute meeting a primary threshold, and upon detecting the object for collection meeting the primary threshold, activate the auxiliary component.

### CROSS-REFERENCE TO RELATED PATENT APPLICATIONS

This application claims the benefit of and the priority to U.S. Provisional Patent Application No. 63/642,072, filed May 3, 2024, the entire contents of which is hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

In some aspects, the techniques described herein relate to a refuse vehicle including: an auxiliary component; a sensor; processing circuitry including one or more processors; and a computer-readable, non-transitory storage medium including instructions that, when executed by the one or more processors, cause the one or more processors to execute a method including: obtaining a dataset from the sensor, the dataset including a primary attribute; detecting an object for collection based on the primary attribute satisfying a primary threshold; and in response to detecting the object for collection based on the primary attribute satisfying the primary threshold, initiating the auxiliary component.

In some aspects, the techniques described herein relate to a refuse vehicle wherein the auxiliary component is one of a hydraulic pump, an electric motor, an E-PTO, and a fuel cell.

In some aspects, the techniques described herein relate to a refuse vehicle, wherein the object is a refuse cart.

In some aspects, the techniques described herein relate to a refuse vehicle, wherein the primary attribute is one of a position of the object, an orientation of the object, a color of the object, a shape of the object, a distance to the object from the refuse vehicle, a confidence value of a presence of the object, and a weight of the object.

In some aspects, the techniques described herein relate to a refuse vehicle, wherein the auxiliary component is coupled to one of a lift assembly, an ejector, a refuse collector, a refuse cart grabber, a refuse compactor, a vehicle access device, a vehicle door, and a hopper door.

In some aspects, the techniques described herein relate to a refuse vehicle, the method further including: receiving a secondary dataset, the secondary dataset including a secondary attribute; determining an interlock condition is satisfied based on the secondary attribute satisfying a secondary threshold; and in response to the interlock condition being satisfied and detecting the object for collection based on the primary attribute satisfying the primary threshold, initiating the auxiliary component.

In some aspects, the techniques described herein relate to a refuse vehicle, the method further including: receiving a secondary dataset, the secondary dataset including a secondary attribute; determining an interlock condition is satisfied based on the secondary attribute satisfying a secondary threshold; in response to the interlock condition being satisfied by the secondary attribute satisfying the secondary threshold, detecting the object for collection based on the primary attribute satisfying the primary threshold; and in response to detecting the object for collection based on the primary attribute satisfying the primary threshold, initiating the auxiliary component.

In some aspects, the techniques described herein relate to a refuse vehicle, the method further including: receiving a tertiary dataset, the tertiary dataset including a tertiary attribute; in response to detecting the object for collection based on the primary attribute satisfying the primary threshold, determining if the tertiary attribute satisfies a tertiary threshold; and in response to the tertiary attribute satisfying the tertiary threshold and detecting the object for collection based on the primary attribute satisfying the primary threshold, initiating the auxiliary component.

In some aspects, the techniques described herein relate to a refuse vehicle, wherein the secondary attribute corresponds to at least one of a power source attribute, a hydraulic system attribute, a high voltage component attribute, a vehicle attribute, an operator attribute, an object attribute, a weather attribute, an obstacle detection, a hopper capacity, a navigation route, a current location, and a user input.

In some aspects, the techniques described herein relate to a refuse vehicle including: an auxiliary component; a sensor; processing circuitry including one or more processors; and a computer-readable, non-transitory storage medium including instructions that, when executed by the one or more processors, cause the one or more processors to execute a method including: obtaining a dataset including a primary attribute, a secondary attribute, and a tertiary attribute; determining if a first interlock condition is met based on the secondary attribute satisfying a secondary threshold; in response to the first interlock condition being met, detecting an object for collection based at least in part on the primary attribute satisfying a primary threshold; determining if a second interlock condition is met by the tertiary attribute satisfying a tertiary threshold; and in response to the second interlock condition being met, initiating the auxiliary component.

In some aspects, the techniques described herein relate to a refuse vehicle wherein the auxiliary component is one of a hydraulic pump, an electric motor, an E-PTO, and a fuel cell.

In some aspects, the techniques described herein relate to a refuse vehicle, wherein the object is a refuse cart.

In some aspects, the techniques described herein relate to a refuse vehicle, wherein the primary attribute is one of a position of the object, an orientation of the object, a color of the object, a shape of the object, a distance to the object from the refuse vehicle, a confidence value of a presence of the object, and a weight of the object.

In some aspects, the techniques described herein relate to a refuse vehicle, wherein the auxiliary component is coupled to one of a lift assembly, an ejector, a refuse collector, a refuse cart grabber, a refuse compactor, a vehicle access device, a vehicle door, and a hopper door.

In some aspects, the techniques described herein relate to a refuse vehicle, wherein the secondary attribute corresponds to at least one of a power source attribute, a hydraulic system attribute, a high voltage component attribute, a vehicle attribute, an operator attribute, an object attribute, a weather attribute, an obstacle detection, a hopper capacity, a navigation route, a current location, and a user input.

In some aspects, the techniques described herein relate to a computer-readable, non-transitory storage medium including instructions that when executed by one or more processors, cause the one or more processors to execute a method including: obtaining a dataset including a primary attribute, a secondary attribute, and a tertiary attribute; determining if a first interlock condition is met based on the secondary attribute satisfying a secondary threshold; in response to the first interlock condition being met, detecting an object for collection based at least in part on the primary attribute satisfying a primary threshold; determining if a second interlock condition is met by the tertiary attribute satisfying a tertiary threshold; and in response to the second interlock condition being met, initiating an auxiliary component of a refuse vehicle.

In some aspects, the techniques described herein relate to a computer-readable, non-transitory storage medium wherein the auxiliary component is one of a hydraulic pump, an electric motor, an E-PTO, and a fuel cell.

In some aspects, the techniques described herein relate to a computer-readable, non-transitory storage medium, wherein the primary attribute is one of a position of the object, an orientation of the object, a color of the object, a shape of the object, a distance to the object from the refuse vehicle, a confidence value of a presence of the object, and a weight of the object.

In some aspects, the techniques described herein relate to a computer-readable, non-transitory storage medium, wherein the auxiliary component is coupled to one of a lift assembly, an ejector, a refuse collector, a refuse cart grabber, a refuse compactor, a vehicle access device, a vehicle door, and a hopper door.

In some aspects, the techniques described herein relate to a computer-readable, non-transitory storage medium, wherein the secondary attribute corresponds to at least one of a power source attribute, a hydraulic system attribute, a high voltage component attribute, a vehicle attribute, an operator attribute, an object attribute, a weather attribute, an obstacle detection, a hopper capacity, a navigation route, a current location, and a user input.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment; and

FIG. 2 is a block diagram of a vehicle, according to an embodiment.

FIG. 3 is a block diagram of a vehicle, according to an embodiment.

FIG. 4 is a top view of a vehicle on a collection route, according to an embodiment.

FIG. 5 is a flow diagram of a method for initiating one or more components of a vehicle, according to an embodiment.

FIG. 6 is a flow diagram of a method for initiating one or more components of a vehicle, according to an embodiment.

FIG. 7 is a flow diagram of a method for initiating one or more components of a vehicle, according to an embodiment.

FIG. 8 is a flow diagram of a method for initiating one or more components of a vehicle, according to an embodiment.

FIG. 9 is a flow diagram of a method for initiating one or more components of a vehicle, according to an embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Systems and methods are described herein relate to refuse vehicles that intelligently predict and prepare for high-power load events, such as lifting and emptying refuse carts. Using onboard sensors and object detection algorithms, the system is configured to identify carts in the vehicle's path and evaluate whether predefined interlock conditions—based on environmental, navigational, or vehicle-specific parameters—are satisfied. When these interlock conditions are met, the system is configured to preemptively initiate auxiliary components, such as an electric power take-off (E-PTO, hydraulic pump spin up, etc.) or hydrogen fuel cell, to ensure sufficient power and hydraulic pressure are available at the moment of collection. This predictive approach can reduce energy waste and improve operational responsiveness.

According to at least one embodiment of the methods and systems described herein, a refuse vehicle (referred to herein as a vehicle) includes at least one sensor coupled thereto to be used in predicting/detecting load events (e.g., events with increase power load such as refuse collection, refuse compaction, etc.). Upon one or more processors (referred to herein as processors) of the vehicle predicting an upcoming load event based on sensor data received by the sensor, the processors prepare for executing the upcoming load event by transmitting a control signal to one or more auxiliary systems or subsystems used during the load event to initiate the one or more auxiliary systems or subsystems.

In an embodiment, the sensor receives image data of an environment surrounding the refuse vehicle. This sensor data (e.g., images) is transmitted to an object detection system to process the sensor data and detect a refuse cart (referred to herein as a cart). Upon detecting the presence of the cart, the object detection system transmits an indication to a control system to transmit one or more control signals to an auxiliary component (e.g., a hydraulic pump, a motor, a fuel cell) to initiate operation of the auxiliary component in preparation for the load event.

In some embodiments, the processors additionally or alternatively execute an interlock check prior to initiating operation of the auxiliary component through the control system. In such embodiments, an interlock system executes one or more computer-implemented methods to more accurately predict a load event. For example, the load event prediction may be based on certain additional conditions (referred to herein as secondary conditions, tertiary conditions, interlock conditions) being met beyond the presence of a cart near the vehicle. In such embodiments, secondary conditions may need to be satisfied prior to initiating operation of the auxiliary component through the control system. Exemplary secondary conditions (or tertiary conditions) may include, but are not limited to, the vehicle traveling below a speed threshold, the vehicle traveling towards the cart, the cart being on a collection side of the vehicle, the cart being on the vehicle's collection route, a battery level above or below a battery threshold, a hydraulic pressure above or below a pressure threshold, a component operating temperature above or below a temperature threshold, an operator present or not present, and/or a weather condition.

The interlock system may receive datasets including various data from various sensors, systems, subsystems, or other devices. By way of example, the data that the interlock system receives from one or more sensors, systems, or subsystems may include one or more current operating parameter attributes of the vehicle, such as speed, steering angle, acceleration, velocity, cart engagement, auxiliary component operation, power source level, hydraulic oil condition, and/or high-voltage component temperature. In some embodiments, the interlock system receives from one or more sensors, systems, or subsystems one or more environmental attributes, such as weather conditions, cart or refuse container attributes (e.g., color, size, orientation, location, branding, text or visual labels affixed to the cart), and/or obstacle conditions (e.g., existence of an obstacle, size of an obstacle, location of an obstacle). In some embodiments, the interlock system receives from one or more sensors, systems, or subsystems one or more navigation attributes, such as route trajectory, refuse collection locations, direction of travel, historical navigation data, and/or date/time.

One or more of these (and/or additional) received attributes may be compared against predetermined and/or received attribute thresholds to determine if the received attribute satisfies a corresponding attribute threshold, thus indicating that the condition is met. Upon determining that the condition is met, the interlock system may transmit an indication that the condition is met to the control system. Upon receiving the indication that the condition is met, the control system transmits a control signal to the auxiliary component to initiate operation of the auxiliary component.

In some embodiments, the interlock system checks one or more secondary conditions, in addition to detecting a presence of a cart by the object detection system, prior to sending an indication to the control system to initiate the auxiliary component. The interlock system and object detection system may operate in parallel or in series. By way of example, the processors may operate the object detection system until a cart is detected. Upon detecting the cart, the processors then execute the interlock system to determine if secondary conditions are met. In other embodiments, the interlock system runs until the interlock condition(s) are met, at which point the object detection system runs. In some embodiments, the interlock system runs continuously in the background, and upon the interlock condition being met, the object detection system is executed. In some embodiments, a secondary attribute is received by the interlock system until the secondary attribute satisfies a secondary threshold, at which point the object detection system begins receiving sensor data (including a primary attribute) to determine if a cart is present. Once the secondary threshold is met and a cart is detected (e.g., the primary attribute satisfies a primary threshold), the interlock system then begins receiving a tertiary attribute to compare against a tertiary threshold. Once the tertiary threshold is met by the tertiary attribute, the interlock system transmits to the control system an indication that all conditions are met and instructions to transmit control signals to the auxiliary component to initiate operation. The control system, in response to receiving the indication, transmits corresponding control signals to the auxiliary component to initiate operation.

In other embodiments, the one or more attributes are compared to their associated attributes in parallel and once all three are met, the indication is sent to the control system.

The auxiliary component may be, for example, a hydraulic pump, a motor, or a fuel cell. The auxiliary component may be part of an auxiliary system and coupled to one or more vehicle devices (referred to herein as devices). Exemplary devices may include, but are not limited to, a lift assembly, an ejector, a refuse collector (e.g., gripper arms or platform), a refuse cart grabber (referred to herein as a cart grabber), a refuse compactor, a vehicle access device (e.g., actuated stairs, actuated platform, actuated step), a vehicle door, and/or a hopper door. In some embodiments, the auxiliary component is cooperatively coupled to the device and aids in operation of the device. For example, an auxiliary system (e.g., a hydraulic system) may include an auxiliary component (e.g., an electric motor) and a device (e.g., a cart grabber). The electric motor may be used to rotate a hydraulic pump and thereby increase hydraulic pressure within the auxiliary system to cause the cart grabber to operate (e.g., extend, retract, articulate).

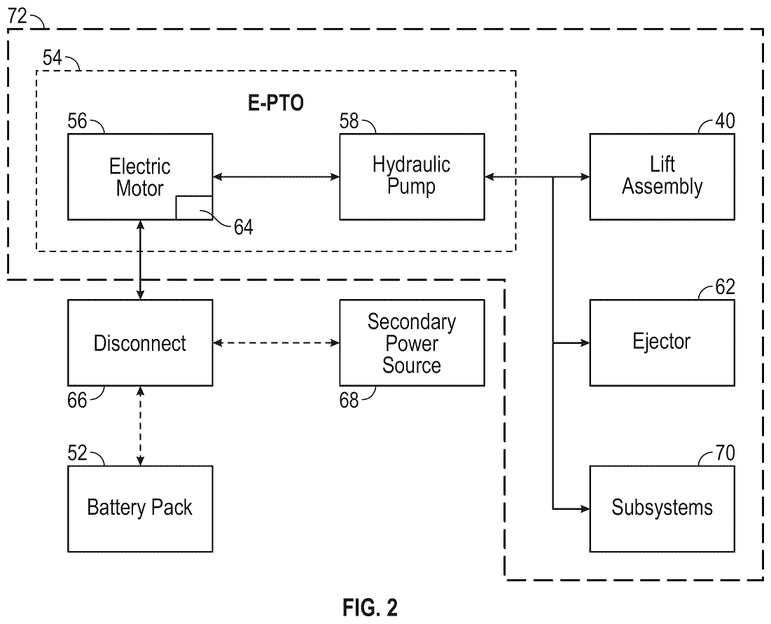

In an exemplary embodiment, the vehicle detects an upcoming cart to collect (and thus an associated increased load requirement) and determines that any additional secondary and/or tertiary conditions are met. Upon detecting the cart and determining that any additional secondary and/or tertiary conditions are met, the controller of the vehicle transmits a control signal to the electric motor to initiate operation and cause a cooperatively coupled hydraulic pump (collectively referred to, in some embodiments, as an electric power take-off or E-PTO, such as the E-PTO system 54 of FIG. 2) to turn, thus preemptively increasing pressure in the auxiliary system prior to the executing the predicted load event.

In various embodiments, initiating operation of the E-PTO (or other auxiliary component) includes initiating a secondary power source onboard the vehicle. For example, a primary power source may include a battery pack that is used to power a drivetrain and various additional subsystems of the vehicle (e.g., navigation, displays, lights, and/or low-load subsystems). The secondary power source may be used to power various additional subsystems (e.g., high-load subsystems such as cart grabbers and compactors). Thus, the auxiliary component may be a secondary power source such as a hydrogen fuel cell, alternator, generator, capacitor, and/or secondary battery. In such embodiments, the control system transmits instructions to the secondary power source to initiate operation (e.g., begin producing electrical power by the hydrogen fuel cell). This electrical power generated by the secondary power source may then be used to power the electric motor which in turn operates the hydraulic pump.

In some embodiments of the systems and methods described herein, inrush current from starting the auxiliary component (e.g., the E-PTO, alternator, or generator) may be used to power an additional device, such as a compactor. By way of example, initiating operation of the E-PTO or alternator may result in an inrush current (e.g., an increase in current prior to reaching steady state). This inrush current is traditionally lost to heat or stored in a battery. However, in certain systems and methods described herein, the inrush current may be used to power an additional auxiliary component such as a compactor at the end of a compaction cycle.

For example, a refuse vehicle traveling along a collection route may detect a refuse cart positioned along the roadside using a forward-facing camera. Upon determining that the detected object satisfies a primary threshold (e.g., the cart's distance, size, and shape match expected parameters), and further determining that the vehicle is within a predefined collection zone (e.g., based on GPS coordinates satisfying a secondary threshold), the system may initiate a hydrogen fuel cell to begin generating electrical power. This electrical power is used to activate an electric motor, which in turn drives a hydraulic pump to pressurize the auxiliary system in preparation for lifting the cart. In this example, a third sensor may simultaneously report that the vehicle's speed has dropped below a tertiary threshold, further confirming readiness for an upcoming lift event. By satisfying all three interlock conditions, the system is able to preemptively energize high-load subsystems without unnecessary energy expenditure during transit. It should be understood that more or fewer interlock conditions may be evaluated, and that the specific nature, order, or configuration of such conditions may be adapted to suit a variety of operating contexts, without departing from the scope or spirit of the present disclosure.

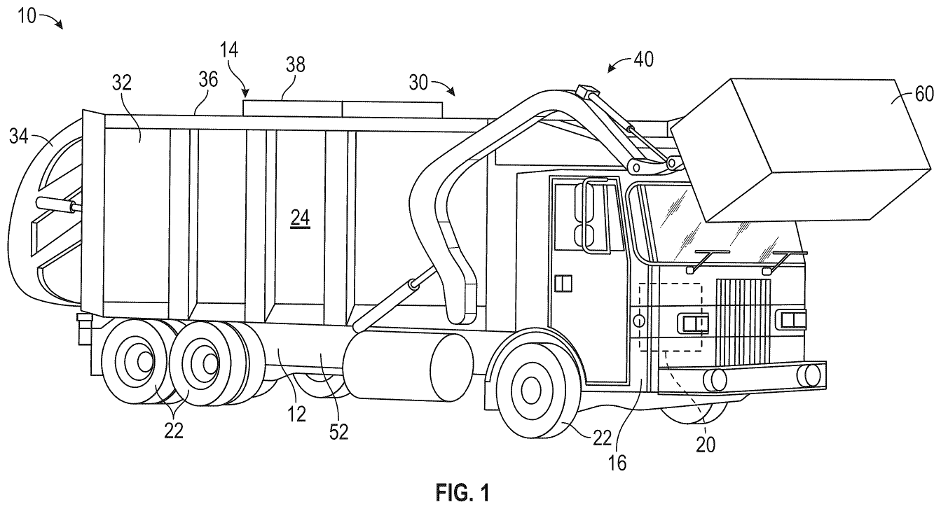

Referring to FIG. 1, a vehicle, shown as refuse vehicle 10 (e.g., garbage truck, waste collection truck, sanitation truck, etc.), includes a chassis, shown as frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include processing circuitry including one or more processors and a computer-readable, non-transitory storage medium configured to execute a method for detecting an object for collection and initiating an auxiliary component in response to a set of threshold conditions.

The refuse vehicle 10 further includes a prime mover 20 coupled to the frame 12 at a position beneath the cab 16. The prime mover 20 provides power to a plurality of motive members, shown as wheels 22, and to other systems of the vehicle (e.g., a pneumatic system, a hydraulic system, an electric system, etc.). A pair of wheels 22 may be coupled to an axle. The refuse vehicle 10 may include at least two axles. In some embodiments, the refuse vehicle 10 may include at least four axles, and may include five axles in various embodiments herein.

The prime mover 20 may be configured to use a variety of fuels (e.g., gasoline, diesel, biodiesel, ethanol, natural gas, etc.), according to various exemplary embodiments. According to an alternative embodiment, the prime mover 20 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and on-board refuse container, in particular, defines a collection chamber 24. In some embodiments, the body 14 includes a plurality of panels, shown as panels 32, a tailgate 34, and a cover 36 that together define the collection chamber 24. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism may be used to support the tailgate 34 on the body 14.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the refuse container 60 (now emptied) to the ground. In some embodiments, the lift assembly 40 operates in coordination with an auxiliary component coupled to the vehicle, such as a hydraulic pump, electric motor, or E-PTO, which may be automatically initiated based on the detection of the refuse container 60 and upon satisfaction of one or more interlock conditions defined by threshold parameters. According to an exemplary embodiment, a door, shown as top door 38, is movably coupled along the cover 36 to seal the opening thereby preventing refuse from escaping the refuse compartment 30 (e.g., due to wind, bumps in the road, etc.).

Referring to FIG. 2, in embodiments in which the refuse vehicle is an electric refuse vehicle (e.g., an E-refuse vehicle, etc.) or a hybrid refuse vehicle (e.g., a vehicle including both electric and hydraulic power systems, etc.), the refuse vehicle may further include an onboard energy storage device. In some embodiments, the onboard energy storage device includes a battery pack 52 that provides power to a motor that produces rotational power to drive the refuse vehicle. The energy storage device can be used to provide power to different subsystems on the refuse vehicle, including one or more auxiliary components such as an electric motor or an E-PTO system. These auxiliary components may be selectively initiated based on detected operational needs or threshold-based interlock conditions, as further described herein.

The refuse vehicle may also include an electric power take-off (E-PTO) system, shown as E-PTO system 54, that is configured to receive electrical power from the battery pack 52 and/or other power sources (such as a hydrogen fuel cell 68) and to convert the electrical power to hydraulic power for different subsystems on the refuse vehicle. In some embodiments, the E-PTO system 54 receives electrical power from the energy storage device and provides the electrical power to an electric motor 56. In such embodiments, the electric motor 56 may drive a hydraulic pump 58 that provides pressurized hydraulic fluid to different vehicle subsystems, such as the lift assembly 40, the packer/ejector, shown as ejector 62, or other subsystems 70 (e.g., the tailgate, etc.). In various embodiments, one or more of these subsystems are responsive to control signals generated by processing circuitry based on sensor-derived attributes. When a primary attribute of a detected object satisfies a primary threshold—optionally in combination with secondary or tertiary interlock conditions—the auxiliary component may be automatically activated to ensure subsystem readiness ahead of a predicted load event.

The E-PTO system may include an E-PTO controller 64. The E-PTO controller 64 may monitor various systems within the refuse vehicle, including the E-PTO system 54. The E-PTO controller 64 may receive data from sensors (not shown) within the system, compare the data to expected values under normal operating conditions, adjust the operation parameters of components of the system, and determine if a critical operating condition exists based on the sensor data. Further, the E-PTO controller 64 may shut down the system and/or the refuse vehicle in response to detecting a critical operating condition. In some embodiments, the refuse vehicle further includes a disconnect 66 positioned between the battery pack 52 and the E-PTO system 54 to allow different vehicle subsystems (e.g., the ejector 62, the lift assembly 40, etc.) to be decoupled and de-energized from the electrical power source. For example, the E-PTO controller 64 may cause the disconnect 66 to be decoupled and de-energized from the electrical power source in response to conditions indicating that the auxiliary component is no longer needed. This architecture enables more efficient management of auxiliary power resources in alignment with real-time object detection and load prediction events.

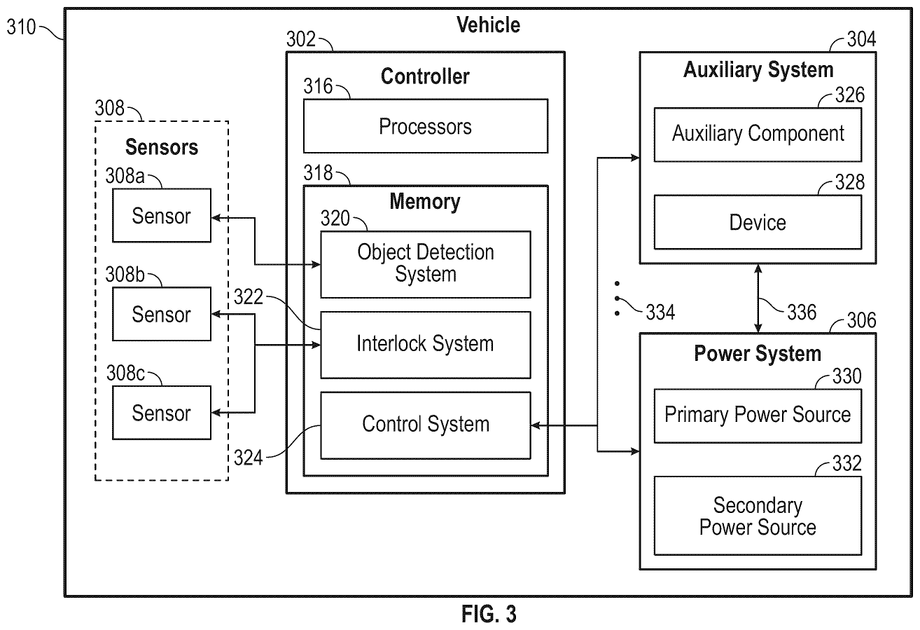

Turning now to FIG. 3, a vehicle 310 is shown. In various embodiments, the vehicle 310 is substantially similar to the refuse vehicle 10 of FIG. 1 and may include some or all of the described components in FIGS. 1-2. The vehicle 310 may include a controller 302, an auxiliary system 304, a power system 306, a sensor 308a, a sensor 308b, and/or a sensor 308c (collectively referred to herein as sensors 308). The controller may include one or more processors (shown as a processor 316) and a memory 318. The memory 318 may include various subsystems or modules stored in non-transitory, computer-readable media. For example, the memory 318 may include an object detection system 320, an interlock system 322, and/or a control system 324.

Controller 302 may be implemented as a general-purpose processor, an application specific integrated circuit (ASIC), one or more field programmable gate arrays (FPGAs), a digital-signal-processor (DSP), and/or circuits containing one or more processing components, circuitry for supporting a microprocessor, a group of processing components, or other suitable electronic processing components. In various embodiments, the controller 302 includes processing circuity for executing instructions stored in the non-transitory, computer-readable media of the memory 318. The processing circuitry may include one or more processors, shown as the processor 316, which may include an ASIC, one or more FPGAs, a DSP, and/or circuits containing one or more processing components or circuitry for supporting a microprocessor, a group of processing components, and/or other suitable electronic processing components. The memory 318 may be any volatile or non-volatile computer-readable storage medium capable of storing data or computer code relating to the methods described herein and instructions to execute the methods described herein. According to an exemplary embodiment, the memory 318 includes computer code modules (e.g., executable code, object code, source code, script code, machine code, etc.) configured for execution by the processor 316. In some embodiments, the processor 316 may represent a collection of processing devices (e.g., servers, data centers, etc.). In such cases, the processor 316 represents the collective processors of the devices, and memory 318 represents the collective storage devices of the devices. The processor 316 may execute one or more of the systems or subsystems stored in the memory 318, such as the object detection system 320, the interlock system 322, and/or the control system 324.

The memory 318 (and by extension, the various subsystems stored in the memory 318, such as object detection system 320, the interlock system 322, and/or the control system 324) may be communicatively coupled (e.g., wiredly or wirelessly) to one or more of the sensors 308. By way of a non-limiting example, the sensor 308a may be communicatively coupled to object detection system 320, the sensor 308b may be communicatively coupled to the interlock system 322, and the sensor 308c may be communicatively coupled to the interlock system 322, as shown in FIG. 3. Though an of the sensors 308 may be coupled to one or more of the systems stored in the memory 318. The object detection system 320, the interlock system 322, and/or the control system 324 may receive sensor datasets including various sensor data from the sensors 308 to which they are communicatively coupled. This received sensor data is stored in the various subsystems and used in executing the methods described herein.

Object detection system 320 may contain instructions for detecting objects (e.g., a cart, a person, an obstacle, an operator, a mailbox, etc.) surrounding the vehicle 310. By way of example, the methods described herein relate to detecting carts for collection by the vehicle 310. However, it should be understood that the methods and systems described herein may be directed to any suitable object that the object detection system 320 detects.

In an embodiment, the object detection system 320 receives a dataset from the sensor 308a. The sensor 308a may be one of various sensors for collecting environmental data surrounding the vehicle 310. For example, the sensor 308a may be one or more of cameras, LiDAR (Light Detection and Ranging) sensors, radar (Radio Detection and Ranging) sensors, ultrasonic sensors, infrared sensors, thermal sensors, laser rangefinders, depth cameras, and/or 3D imaging sensors. While a sensor 308a in the singular is shown in FIG. 3 for ease of description, the sensor 308a may include one or more sensors coupled to the vehicle 310. Likewise, the sensor 308b and the sensor 308c may also include multiple sensors. In some embodiments, the sensor 308a may not be physically coupled to the vehicle 310, rather, the sensor 308a may be physically coupled to another vehicle or other object (e.g., a perception module or a satellite). In such embodiments, the sensor 308a is communicatively coupled to the controller 302 through a network (not shown). Likewise, any of the sensors 308 may be physically removed from the vehicle 310 and communicatively coupled to the controller 302 through the network (not shown).

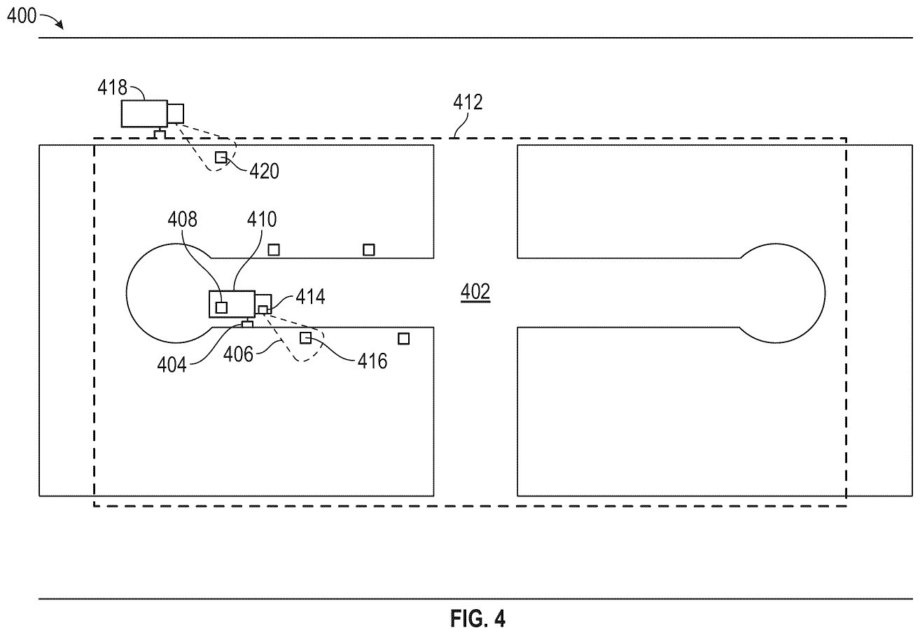

The sensor 308a receives perception data from an area defining a perception area (shown in FIG. 4 as a perception area 416) around the vehicle 310, the perception data including one or more object attributes of an object near the vehicle 310. The object attribute may be considered, in some embodiments, as a primary attribute. The primary attribute may be used to detect the object near the vehicle 310 within the perception area. Detecting the object by the object detection system 320 may include detecting the presence of the object near the vehicle 310 and/or detecting various characteristics of the object (e.g., color, text on the object, position of the object, distance to the object, orientation of the object, type of object, size of the object, an estimated weight of the object, a volume of the object). The perception data may include, in some embodiments, images from the sensor 308a (e.g., a still camera or video camera). The object detection system 320 may include image processing instructions for processing the received images to extract the various characteristics and/or attributes of the images. In some embodiments, the object detection system 320 determines a confidence value associated with the likelihood that the detected object or characteristic is correctly detected (e.g., a higher confidence value signifies a higher likelihood that a detected cart is present).

In an exemplary embodiment, the vehicle 310 includes a camera (the sensor 308a). The camera collects image data from a perception area surrounding the vehicle 310 and transmits the collected data to the object detection system 320. The object detection system 320 receives the transmitted image data and processes the images to extract various characteristics and/or attributes (e.g., size, orientation, location) of an object within the images and determines a distance to the position of the object based on known, positional datums of the camera in relation to the vehicle 310. The object detection system 320 detects the presence of the object based on the extracted characteristics and/or attributes. In at least one embodiment, the sensor 308a is a standalone camera specifically utilized to detect carts. In other embodiments, the sensor 308a is used for multiple perception functions such as autonomous and semi-autonomous driving.

Upon detecting the presence (or other attribute) of the object, the object detection system 320 transmits an indication to the interlock system 322 indicating the presence (or other detected attribute) of the object.

The interlock system 322 contains instructions for determining when to initiate the operation of the auxiliary component 326 and/or the secondary power system 332 of the vehicle 310. The auxiliary system 304 may be substantially similar to an auxiliary system 72 of FIG. 2. For example, the auxiliary system 304 of FIG. 3 may include an auxiliary component 326 that corresponds to one or more components of the E-PTO system 54 of FIG. 2 (e.g., the electric motor 56 and/or the hydraulic pump 58). The auxiliary system 304 of FIG. 3 may include a device 328 which may correspond to one or more of the lift assembly 40, the ejector 62, and/or the other subsystems 70 of FIG. 2. In various embodiments, the interlock system 322 contains instructions for initiating the operation (through control signals transmitted from the control system 324) of an electric motor or hydrogen fuel cell.

In an embodiment, the interlock system 322 determines to initiate the operation of the auxiliary component 326 based on the detection of an object (e.g., a cart) by the object detection system 320. However, in various other embodiments, the interlock system 322 determines to initiate the operation of the auxiliary component 326 based on one or more additional interlock conditions. Interlock conditions may be conditions that must be satisfied (in addition to the presence of the object) prior to the interlock system 322 determining to initiate operation of the auxiliary component 326. An interlock condition may be considered satisfied when one or more secondary attributes satisfy corresponding thresholds. The secondary attributes may be received from the sensor 308b and/or the sensor 308c. Secondary attributes may correspond to, for example, an environment attribute, a vehicle attribute, and/or a navigation attribute.

Secondary attributes that are environment attributes may include, but are not limited to weather conditions, cart or refuse container attributes (e.g., color, size, orientation, location, branding, labels), and/or obstacle conditions (e.g., existence of an obstacle, size of an obstacle, location of an obstacle). Secondary attributes that are vehicle attributes may include, but are not limited to one or more current operating parameter attributes of the vehicle, such as speed, steering angle, acceleration, velocity, cart engagement, auxiliary component operation, power source level, hydraulic oil condition, and/or high-voltage component temperature. Secondary attributes that are navigation attributes may include, but are not limited to route trajectory, refuse pickup locations, direction of travel, historical navigation data, and/or date/time.

Additional secondary attributes may include power source attributes, a hydraulic system attributes, a high voltage component attribute, a vehicle attribute, an operator attribute, an object attribute, a weather attribute, an obstacle detection, a hopper capacity, a navigation route, a current location, and a user input.

By way of example, an environmental secondary attribute may include a weather condition, such as the detection of active precipitation via a rain sensor, or elevated ambient temperature exceeding a defined threshold (e.g., 95° F.), which may affect component readiness or route execution. Cart or refuse container attributes may include size classification (e.g., greater than 60 gallons), orientation angle (e.g., rotated more than 45 degrees from a default position), or visual identifiers, such as route-specific branding, color codes, or applied QR labels that match a service profile. Obstacle detection attributes may include the presence of a foreign object (e.g., a mailbox, parked bicycle, or pedestrian) located within a defined engagement zone, as well as the object's size and proximity to the lift path.

Vehicle-based secondary attributes may include real-time speed and acceleration, steering angle, confirmation of cart engagement readiness, or the current state of auxiliary systems (e.g., whether an electric power take-off is actively pressurizing a hydraulic circuit). Power system attributes may include battery state of charge, power draw rate, fuel cell voltage, or electrical subsystem health. Hydraulic system attributes may include accumulator pressure or oil temperature relative to a defined range. High-voltage component attributes may include inverter or controller temperatures, bus voltage presence, or load status.

Additional secondary attributes may include operator status (e.g., seat sensor engaged, safety belt latched), object-specific features (e.g., shape conformity or barcode match), hopper capacity (e.g., less than 80% full based on volumetric sensor data), and user interface inputs (e.g., operator selection of “ready to lift” or “skip location” via a touchscreen interface). Navigation-specific attributes may include confirmation that the vehicle is within a scheduled collection corridor, on a reverse-lane pickup pattern, or within a proximity radius of a known service address at a correct service time. Together, these secondary attributes—whether considered independently or in combination—provide enhanced context for condition-based control of auxiliary component operation.

One or more of these (and/or additional) received attributes may be compared against predetermined and/or received attribute thresholds to determine if the received attribute satisfies a corresponding attribute threshold, thus indicating that the condition is met. Upon determining that the condition is met, the interlock system 322 may transmit an indication that the condition is met to the control system 324. Upon receiving the indication that the condition is met, the control system 324 transmits a control signal to the auxiliary component 326 to initiate operation of the auxiliary component 326.

In some embodiments, the interlock system 322 checks one or more secondary conditions, in addition to detecting a presence of a cart by the object detection system 320, prior to sending an indication to the control system 324 to initiate the auxiliary component 326. The interlock system 322 and object detection system 320 may operate in parallel or in series. By way of example, the processors may operate the object detection system 320 until a cart is detected. Upon detecting the cart, the processors then execute the interlock system 322 to determine if secondary conditions are met. In other embodiments, the interlock system 322 runs until the interlock condition(s) are met, at which point an indication is sent by the interlock system 322 to the object detection system 320 that the secondary condition is met and to initiate the object detection system 320. In some embodiments, the interlock system 322 runs continuously in the background, and upon the interlock condition being met, the object detection system 320 is executed. In some embodiments, a secondary attribute is received by the interlock system 322 until the secondary attribute satisfies a secondary threshold, at which point the object detection system 320 begins receiving sensor data (including a primary attribute) to determine if a cart is present. Once the secondary threshold is met and a cart is detected (e.g., the primary attribute satisfies a primary threshold), the interlock system 322 then begins receiving a tertiary attribute to compare against a tertiary threshold. Once the tertiary threshold is met by the tertiary attribute, the interlock system 322 transmits to the control system 324 an indication that all conditions are met and instructions to transmit control signals to the auxiliary component 326 to initiate operation. The control system 324, in response to receiving the indication, transmits corresponding control signals to the auxiliary component 326 to initiate operation.

Secondary attributes may indicate probable loading conditions to increase the accuracy of predicting a load event of the vehicle 310. For example, in receiving (from the sensor 308b, such as a GPS module) a geographical position attribute (e.g., GPS coordinates) of the vehicle 310, the received geographical position attribute may be compared to a geographical position threshold (e.g., a geofenced area) to determine if the vehicle 310 is within the geofenced area. The geofenced area may correlate to a neighborhood along a collection route of the vehicle 310 and can be used to more accurately predict that carts detected when the vehicle 310 is in the geofenced area are more likely to be loaded. Additional interlock conditions that the interlock system 322 may use to determine whether to transmit instructions to initiate operation of the auxiliary component 326 include the vehicle 310 traveling at a speed above or below a speed threshold, the vehicle 310 traveling in a specific direction (e.g., such that the object is on a loading side of the vehicle 310), the destination of the vehicle 310, text on the cart matching a known text indicating that the cart is associated with the vehicle 310, an indication that there is no personnel near the cart, a battery level below or above a threshold, a fuel level above or below a fuel threshold, and/or a current compaction state above or below a threshold. The sensor 308b may collect data related to a first secondary attribute (e.g., vehicle 310 position) and the sensor 308c may collect data related to a second secondary attribute (e.g., vehicle 310 speed).

The auxiliary system 304 may include one or more auxiliary components (e.g., the auxiliary component 326) and/or devices (e.g., the device 328). In an exemplary embodiment, the auxiliary component 326 may be an E-PTO, such as the E-PTO system 54 of FIG. 2. The auxiliary system 304 may be a hydraulic system that drives one or more hydraulic devices (e.g., the device 328 such as a lift assembly, an ejector, a compactor, etc.). The hydraulic system operates (e.g., the device 328 extends, retracts, articulates) in some embodiments due to increased pressure within one or more hydraulic lines caused by a hydraulic pump spinning. The hydraulic pump is coupled to an electric motor that spins the hydraulic pump to cause an increase in pressure. Spinning the electric motor to increase pressure requires power from one or more power sources (e.g., the secondary power system 332). As such, reducing the operation of the auxiliary component 326 to only the times at which it is needed is advantageous as it reduces power consumption. However, there is often a lag between the initiation of the electric motor and reaching a working pressure of the hydraulic system. As such, the interlock system 322 provides a benefit of reducing power consumption between load events by only operating the electric motor when needed, but also reducing lag time for executing the load event by initiating the operation of the electric motor prior to arriving at a location where the predicted load event is to take place.

In some embodiments, the auxiliary component 326 is electrically coupled to a primary power system 330. The primary power system 330 may be a battery, hydrogen fuel cell, internal combustion engine, nuclear reactor, or other means of providing power to the vehicle 310. In an exemplary embodiment, the primary power system 330 is a battery pack coupled to the vehicle 310. In some embodiments, the auxiliary component 326 is electrically coupled to the secondary power system 332 (shown by an electrical connection 336). In an exemplary embodiment, the primary power system 330 is a battery back and the secondary power system 332 is a hydrogen fuel cell. However, the secondary power system 332 may be any other suitable power source, such as an internal combustion engine, a battery pack, and/or a capacitor.

In some embodiments, the secondary power system 332 to which the auxiliary component 326 is electrically coupled must be initiated in order for the auxiliary component 326 to initiate operation. For example, the vehicle 310 is powered by a battery pack (the primary power system 330). The lift assembly (e.g., the auxiliary component 326) which is used for engaging with a cart and loading the contents of cart into a compaction area within the vehicle 310 is powered by a hydrogen fuel cell (e.g., the secondary power system 332). The hydrogen fuel cell is not in operation between load events because the lift assembly is only needed during lift events. Thus, upon the controller 302 predicting a load event (through execution of the various subsystems stored within the memory 318), control signals 334 are transmitted to the secondary power system 332 and or the auxiliary component 326 to initiate operation to build pressure within the hydraulic system (e.g., the auxiliary system 304) to actuate the lift assembly.

In some embodiments, the auxiliary component 326 is electrically coupled to additional auxiliary components (e.g., additional motors) or other devices (e.g., a compactor). In such embodiments, an inrush current produced during the initial transitory electrical state of the auxiliary component 326 may be transmitted to the additionally coupled auxiliary component or device. For example, during startup of the auxiliary component 326, the processor 316 may adjust the flow of electricity through one or more switches/disconnects to transmit the inrush current to a second auxiliary component (not shown) coupled to a compactor. When the additional inrush current is transmitted to the second auxiliary component, in some embodiments, the controller 302 also transmits control signals to the secondary auxiliary system to initiate operation to utilize the inrush current. For example, the controller 302 may delay a compaction cycle of collected refuse until a load event is predicted and the auxiliary component 326 is initiated. By doing so, the otherwise wasted inrush current produced during the startup of the auxiliary component 326 is utilized during the compaction of the refuse. As such, a predicted load event may result in control signals 334 being transmitted by the object detection system 320 or the interlock system 322 to various subsystems (e.g., the auxiliary component 326 and the second auxiliary component) simultaneously or near simultaneously.

Turning now to FIG. 4, a system 400 is shown for executing one or more of the methods described in FIGS. 1-3. The system 400 may include a vehicle 410 with an auxiliary component 408, a device 406, and/or a sensor 414. The auxiliary component 408 may be used to provide hydraulic pressure to the device 406. As shown in FIG. 4, the device 406 may be a lift assembly for lifting a cart 404 and articulating such that the contents of the cart 404 are emptied into the vehicle 410. The sensor 414 may receive image data for a perception area 416. As illustrated in FIG. 4, the cart 404 may be within the perception area 416 during operation of the vehicle 410. The captured (or obtained) image data of the cart 404, including data related to one or more attributes of the cart 404, is transmitted in a dataset to one or more subsystems of the vehicle 410 to be processed. One or more processors of a controller of the vehicle 410 process the images to determine the presence (and/or other attribute) of the cart within the perception area 416. In some embodiments, the perception area 416 is positioned such that any cart 404 detected within the perception area 416 is (or will soon be) within a reach of the device 406 during a collection movement.

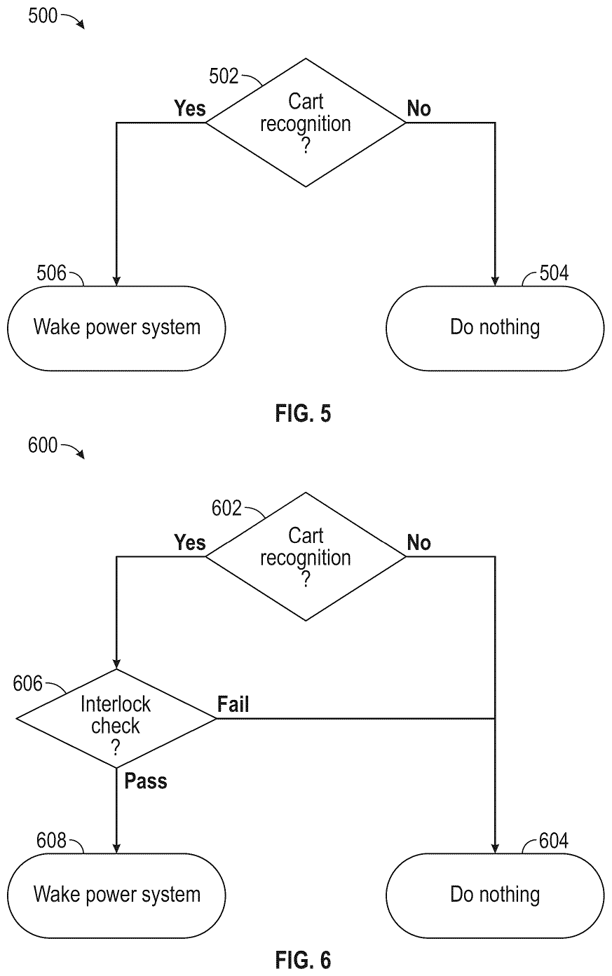

The processors process the images to extract one or more primary attributes of the cart 404, such as a distance in front of the vehicle 410 and/or a distance from a drivable surface 402 upon which the vehicle 410 is traveling. In some embodiments, the attribute of the cart 404 is a confidence level of an object detection system of the vehicle 410 that determines the presence of the cart 404. In other embodiments, the confidence level is determined from an object detection system of the vehicle 410. One or more of these primary attributes are compared to corresponding thresholds (e.g., predetermined threshold within a memory of the controller, received by a user input, received from a network). In some embodiments, the primary threshold is based on a type of vehicle 410, a type of device 406, and/or a type of auxiliary component 408. Upon the primary attribute satisfying the primary threshold (e.g., the object detection system has a satisfactorily high confidence level of a presence of the cart 404, the cart 404 being within a predefined distance from the vehicle 410, the cart 404 being within a predefined distance from the drivable surface 402), an indication of the presence of cart 404 is sent to an interlock system (e.g., interlock system 322 of FIG. 3) to determine if all necessary conditions are satisfied. In some embodiments, a presence of the cart 404 is the only necessary condition to be satisfied (e.g., as shown in FIG. 5).

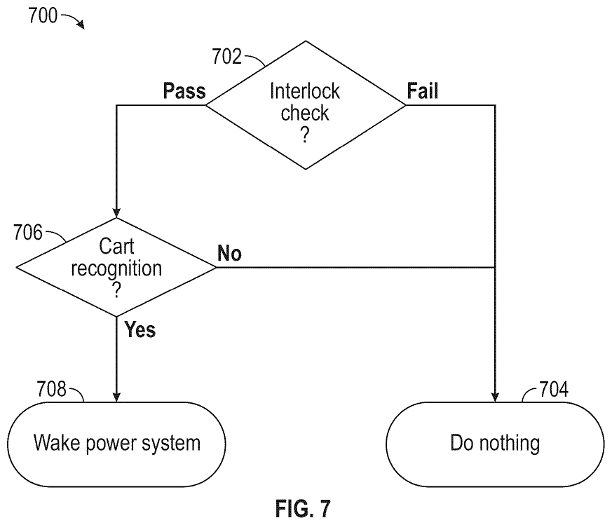

In other embodiments, additional interlock conditions must be met prior to initiation of the auxiliary component 408 (e.g., as shown in FIGS. 6-7). For example, an interlock condition may be that the vehicle 410 must be within a predefined geofenced area 412 (e.g., along a collection route or within a neighborhood) prior to initiating the auxiliary component 408 upon detection of the cart 404. As shown in FIG. 4, the vehicle 410 is within the threshold of the predefined geofenced area 412, which the processors determine by comparing a received geographical position (e.g., GPS coordinates) to the predefined geofenced area 412. The current geographical position received by the processors may be transmitted by an additional sensor (not shown), such as a GPS receiver that receives global positioning information, in a secondary dataset with a secondary attribute (e.g., geographic positional coordinates). This secondary attribute is extracted from the secondary dataset and compared to a secondary threshold (e.g., the predefined geofenced area 412) to determine if the secondary threshold is satisfied. Upon determining, by the processor, that secondary attribute is satisfied (e.g., within the predefined geofenced area 412), an instruction is transmitted to a control system of the vehicle 410 to transmit control signals to the auxiliary component 408 (or power source) to initiate operation in preparation for collection of the cart 404 (e.g., a load event). In other words, a load event is predicted when both the primary threshold and the secondary threshold are satisfied, and a control signal is then sent to an auxiliary component to initiate operation of the auxiliary component in preparation of executing the predicted load event.

In contrast, a vehicle 418 detecting a cart 420 would not initiate operation of the auxiliary component in a system requiring both the primary threshold and the secondary threshold to be satisfied because the secondary threshold (e.g., the geofence threshold) would not be satisfied by the vehicle 418 because it is outside of the predefined geofenced area 412. In some embodiments, there are multiple alternative secondary thresholds that may be satisfied to initiate operation of the auxiliary component.

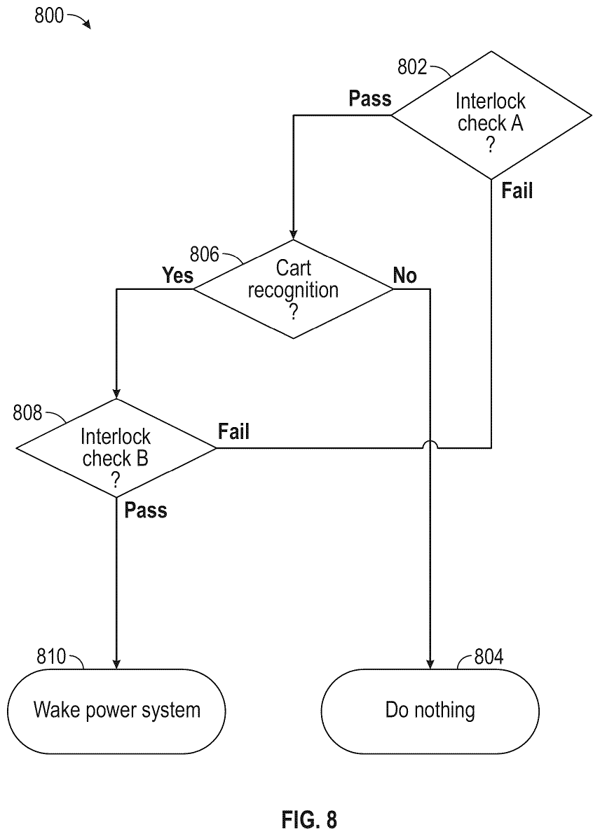

Additionally, in some embodiments, a tertiary threshold must be satisfied to initiate operation of the auxiliary component (e.g., as shown in FIG. 8). In such embodiments, a tertiary dataset is received by the processors from a third sensor, the tertiary dataset including one or more tertiary attributes (e.g., a speed of the vehicle 410). The tertiary attribute is extracted from the tertiary dataset and compared against a tertiary threshold, as described with the primary threshold and the secondary threshold. Upon determining that the tertiary attribute satisfies the tertiary threshold (and the primary and secondary threshold remain satisfying the corresponding primary and secondary threshold), an indication that all three thresholds are satisfied is transmitted to the control system with instructions to transmit control signals to initiate operation of the auxiliary component.

Turning now to FIG. 5, a method 500 for initiating an auxiliary component is shown. The method 500 may be one embodiment of the methods described in FIGS. 1-4, and can be executed by one or more processors (referred to herein as a processor) of a vehicle. In particularity, the method 500 illustrates a system in which a single threshold (e.g., a primary threshold, such as the presence of a cart) must be satisfied to initiate operation of an auxiliary component.

At step 502, a primary dataset is received by the processor from a sensor. The primary dataset may include perception data from the sensor, such as images, radar data, sonar data, LiDAR data, thermal imaging data. The processors process the primary dataset to extract one or more primary attributes from the primary dataset, such as a type of object being perceived by the sensor, a distance to the object, an orientation of the object, text on the object, etc. Upon extracting the primary attributes, the processors then determine whether a specific object (e.g., a cart) is present within a predefined area in relation to the vehicle and if the present cart is to be loaded (e.g., if its color matches a colored cart associated with the vehicle or if known text characterizing it as associated with a pickup route of the vehicle is present). Various text or visual indicators (e.g., a QR code or other distinguishable visual element) may be used detected for us in determining the presence of the object.

If at step 502 the processor determines that there is no cart for collection present, the method 500 continues to step 504 in which the processors do not initiate operation of the auxiliary component and instead continues to search/detect a cart at step 502.

If at step 502 the processor determines that there is a cart for collection present, the method 500 continues to step 506. At step 506, the processor transmits control signals to the auxiliary component such as an E-PTO, or secondary power source, such as a hydrogen fuel cell, to initiate operation of the auxiliary component or secondary power source prior to arriving at the detected cart. Upon completion of the loading event, the processor may send a subsequent control signal to end operation of the auxiliary component or secondary power source until a cart is recognized again. In some embodiments, the instructions are sent in order to initiate operation early enough to result in appropriate hydraulic pressure is present prior to arriving at the cart for collection. A current speed of the vehicle may be used in calculating the timing of when to initiate operation/transmit instructions.

For example, a refuse vehicle may travel through a neighborhood and approach a known pickup location along its collection route. As the vehicle proceeds, a forward-facing camera collects image data that is analyzed by an onboard object detection system. The system identifies a refuse cart positioned within a predefined lateral and longitudinal range relative to the vehicle and extracts object attributes such as color, size, and distance. Based on these primary attributes, the processor determines that the detected object satisfies a primary threshold indicating the presence of a cart for collection. In response, the processor transmits a control signal to initiate operation of an auxiliary component, such as an E-PTO system, prior to the vehicle reaching the cart. The E-PTO system activates an electric motor and pressurizes a hydraulic circuit used to operate the lift assembly. By initiating the auxiliary component in advance of the lift event, the system ensures that sufficient hydraulic pressure is available to engage and lift the cart without delay, while avoiding unnecessary energy use during transit. In this example, no additional interlock conditions beyond the detected cart presence are required, aligning with the single-threshold logic of method 500.

Turning now to FIG. 6, a method 600 for initiating an auxiliary component is shown. The method 600 may be one embodiment of the methods described in FIGS. 1-4, and can be executed by one or more processors (referred to herein as a processor) of a vehicle. In particularity, the method 600 illustrates a system in which two thresholds (e.g., a primary threshold, such as the presence of a cart, and a secondary threshold, such as being located in a geofenced position) must be satisfied to initiate operation of an auxiliary component.

At step 602, a primary dataset is received by the processor from a sensor. The primary dataset may include perception data from the sensor, such as images, radar data, sonar data, LiDAR data, thermal imaging data. The processors process the primary dataset to extract one or more primary attributes from the primary dataset, such as a type of object being perceived by the sensor, a distance to the object, an orientation of the object, text on the object, etc. Upon extracting the primary attributes, the processors then determine whether a specific object (e.g., a cart) is present within a predefined area in relation to the vehicle and if the present cart is to be loaded (e.g., if its color matches a colored cart associated with the vehicle or if known text characterizing it as associated with a pickup route of the vehicle is present).

If at step 602 the processor determines that there is no cart for loading present, the method 600 continues to step 604 in which the processors do not initiate operation of the auxiliary component and instead continue to search/detect a cart at step 602.

If at step 602 the processor determines that there is a cart for loading present, the method 600 continues to step 606. At step 606, the processor determines if a secondary threshold (e.g., an interlock condition) is satisfied. The processor receives a secondary dataset from a second sensor. The secondary dataset may include environmental data, navigation data, and/or vehicle data. Within the received data is included environmental attributes of an environment surrounding the vehicle, navigational attributes of a navigation upon which the vehicle is traveling, and/or vehicle attributes of various operating parameters of the vehicle. This dataset is processed to extract the various secondary attributes stored within the secondary dataset. A secondary attribute is compared against a known secondary threshold to determine if the threshold is met, and thereby the secondary condition is met.

If at step 606 the processor determines that the secondary condition is not met because the secondary threshold is not satisfied, the method 600 continues to step 604 at which the processor does not initiate operation of an auxiliary component and instead continues to receive secondary data and determine if the secondary threshold is met (e.g., returns to step 606).

If at step 606 the processor determines that the secondary condition is met because the secondary threshold is satisfied, the method 600 continues to step 608. At step 608, the processor transmits control signals to the auxiliary component such as an E-PTO, or secondary power source, such as a hydrogen fuel cell, to initiate operation of the auxiliary component or secondary power source prior to arriving at the detected cart. Upon completion of the loading event, the processor may send a subsequent control signal to end operation of the auxiliary component or secondary power source until a cart is recognized again.

For example, as illustrated in FIG. 6, a refuse vehicle may travel along a scheduled collection route through a neighborhood defined by a geofenced zone. As the vehicle approaches a curbside cart, a forward-mounted camera captures image data, which is processed to extract object attributes including shape, size, distance, and orientation. The system determines that these attributes satisfy a primary threshold, confirming the presence of a cart positioned for collection. Simultaneously, a navigation module provides location data indicating that the vehicle is within a predefined geofence associated with a designated pickup area. This location information, included in a secondary dataset, satisfies the corresponding secondary threshold.

In response to both the primary threshold (cart detection) and the secondary threshold (geofence condition) being met, the processor transmits a control signal to initiate an auxiliary component, such as an electric power take-off (E-PTO) or a hydrogen fuel cell. The auxiliary component begins operating in advance of the lift event, ensuring that adequate hydraulic pressure or electrical output is available by the time the cart is within the engagement range of the lift assembly. If either condition had not been satisfied—such as detecting a cart outside of the geofence—the system would have deferred activation of the auxiliary component, avoiding unnecessary power expenditure.

Turning now to FIG. 7, a method 700 for initiating an auxiliary component is shown. The method 700 may be one embodiment of the methods described in FIGS. 1-4, and can be executed by one or more processors (referred to herein as a processor) of a vehicle. In particularity, the method 700 illustrates a system in which two thresholds (e.g., a primary threshold, such as the presence of a cart, and a secondary threshold, such as being located in a geofenced position) must be satisfied to initiate operation of an auxiliary component.

At step 702, the processor determines if a secondary threshold (e.g., an interlock condition) is satisfied. The processor receives a secondary dataset from a second sensor. The secondary dataset may include environmental data, navigation data, and/or vehicle data. Within the received data is included environmental attributes of an environment surrounding the vehicle, navigational attributes of a navigation upon which the vehicle is traveling, and/or vehicle attributes of various operating parameters of the vehicle. This dataset is processed to extract the various secondary attributes found within the secondary dataset. A secondary attribute is compared against a known secondary threshold to determine if the threshold is met, and thereby the secondary condition is met.

If at step 702 the processor determines that the secondary condition is not met because the secondary threshold is not satisfied, the method 700 continues to step 704 at which the processor does not initiate operation of an auxiliary component and instead continues to receive secondary data and determine if the secondary threshold is met (e.g., returns to step 702).

If at step 702 the processor determines that the secondary condition is met because the secondary threshold is satisfied, the method 700 continues to step 706. At step 706, a primary dataset is received by the processor from a sensor. The primary dataset may include perception data from the sensor, such as images, radar data, sonar data, LiDAR data, thermal imaging data. The processors process the primary dataset to extract one or more primary attributes from the primary dataset, such as a type of object being perceived by the sensor, a distance to the object, an orientation of the object, text on the object, etc. Upon extracting the primary attributes, the processors then determine whether a specific object (e.g., a cart) is present within a predefined area in relation to the vehicle and if the present cart is to be loaded (e.g., if its color matches a colored cart associated with the vehicle or if known text characterizing it as associated with a pickup route of the vehicle is present).

If at step 706 the processor determines that there is no cart for loading present, the method 700 continues to step 704 in which the processors do not initiate operation of the auxiliary component and instead continues to search/detect a cart at step 706.

If at step 706 the processor determines that there is a cart for loading present, the method 700 continues to step 708. At step 708, the processor transmits control signals to the auxiliary component such as an E-PTO, or secondary power source, such as a hydrogen fuel cell, to initiate operation of the auxiliary component or secondary power source prior to arriving at the detected cart. Upon completion of the loading event, the processor may send a subsequent control signal to end operation of the auxiliary component or secondary power source until a cart is recognized again.

For example, as illustrated in FIG. 7, a refuse vehicle traveling along a suburban collection route receives data from a navigation module indicating that it has entered a predefined geofenced collection zone. This location data constitutes a secondary dataset, and the extracted geographic attribute is compared to a secondary threshold representing the geofence boundary. Upon confirming that the vehicle is within the target zone, the processor proceeds to step 706 to evaluate sensor input for cart detection.

At this stage, a forward-facing camera provides a primary dataset consisting of image frames from the vehicle's environment. These frames are processed to extract primary attributes such as object contour, position, and identification markers (e.g., branding, color, or barcode). The system identifies a refuse cart located along the roadside and confirms that the cart satisfies the primary threshold by matching its size, distance, and label characteristics to a known cart profile associated with the current route.

Because both the geofence location (secondary threshold) and the cart detection (primary threshold) are satisfied, the processor transmits a control signal to initiate an auxiliary component, such as an E-PTO system or a hydrogen fuel cell. This early activation ensures that the hydraulic lift system is pressurized and ready for engagement by the time the vehicle aligns with the cart. If either condition had not been met-for example, if the cart were detected outside the geofenced area-the system would have refrained from energizing the auxiliary component, thereby conserving energy and reducing system wear.

Turning now to FIG. 8, a method 800 for initiating an auxiliary component is shown. The method 800 may be one embodiment of the methods described in FIGS. 1-4, and can be executed by one or more processors (referred to herein as a processor) of a vehicle. In particularity, the method 800 illustrates a system in which three thresholds (e.g., a primary threshold, such as the presence of a cart; a secondary threshold, such as being located in a geofenced position; and a tertiary threshold, such as a speed) must be satisfied to initiate operation of an auxiliary component.

At step 802, the processor determines if a secondary threshold (e.g., an interlock condition) is satisfied. The processor receives a secondary dataset from a second sensor. The secondary dataset may include environmental data, navigation data, and/or vehicle data. Within the received data is included environmental attributes of an environment surrounding the vehicle, navigational attributes of a navigation upon which the vehicle is traveling, and/or vehicle attributes of various operating parameters of the vehicle. This dataset is processed to extract the various secondary attributes found within the secondary dataset. A secondary attribute is compared against a known secondary threshold to determine if the threshold is met, and thereby the secondary condition is met.

If at step 802 the processor determines that the secondary condition is not met because the secondary threshold is not satisfied, the method 800 continues to step 804 at which the processor does not initiate operation of an auxiliary component and instead continues to receive secondary data and determine if the secondary threshold is met (e.g., returns to step 802).

If at step 802 the processor determines that the secondary condition is met because the secondary threshold is satisfied, the method 800 continues to step 806. At step 806, a primary dataset is received by the processor from a sensor. The primary dataset may include perception data from the sensor, such as images, radar data, sonar data, LiDAR data, thermal imaging data. The processors process the primary dataset to extract one or more primary attributes from the primary dataset, such as a type of object being perceived by the sensor, a distance to the object, an orientation of the object, text on the object, etc. Upon extracting the primary attributes, the processors then determine whether a specific object (e.g., a cart) is present within a predefined area in relation to the vehicle and if the present cart is to be loaded (e.g., if its color matches a colored cart associated with the vehicle or if known text characterizing it as associated with a pickup route of the vehicle is present).

If at step 806 the processor determines that there is no cart for loading present, the method 800 continues to step 804 in which the processors do not initiate operation of the auxiliary component and instead continues to search/detect a cart at step 806.

If at step 806 the processor determines that there is a cart for loading present, the method 800 continues to step 808. At step 808, the processor determines if a tertiary threshold (e.g., an interlock condition) is satisfied. The processor receives a tertiary dataset from a tertiary sensor. The tertiary dataset may include environmental data, navigation data, and/or vehicle data. Within the received data is included environmental attributes of an environment surrounding the vehicle, navigational attributes of a navigation upon which the vehicle is traveling, and/or vehicle attributes of various operating parameters of the vehicle. This dataset is processed to extract the various tertiary attributes found within the tertiary dataset. A tertiary attribute is compared against a known tertiary threshold to determine if the threshold is met, and thereby the tertiary condition is met.

If at step 806 the processor determines that the tertiary condition is not met because the tertiary threshold is not satisfied, the method 800 continues to step 804 at which the processor does not initiate operation of an auxiliary component and instead continues to receive tertiary data and determine if the tertiary threshold is met (e.g., returns to step 808).

If at step 806 the processor determines that the tertiary condition is met because the tertiary threshold is satisfied, the method 800 continues to step 810. At step 810, the processor transmits control signals to the auxiliary component such as an E-PTO, or secondary power source, such as a hydrogen fuel cell, to initiate operation of the auxiliary component or secondary power source prior to arriving at the detected cart. Upon completion of the loading event, the processor may send a subsequent control signal to end operation of the auxiliary component or secondary power source until a cart is recognized again.

For example, as illustrated in FIG. 8, a refuse vehicle operating in an urban environment receives navigation data indicating that it is traveling along a mapped pickup route and has entered a predefined geofenced service zone. This data constitutes a secondary dataset, and upon determining that a geographic attribute of the dataset satisfies a corresponding secondary threshold, the processor proceeds to object detection.

At step 806, a forward-facing sensor (e.g., camera or LiDAR unit) captures a primary dataset representing the environment in front of the vehicle. The processor extracts primary attributes—such as object shape, label, and spatial position—and determines that a refuse cart is positioned within a designated detection zone and matches route-specific identifiers (e.g., branded markings or assigned colors). The presence of the cart satisfies the primary threshold.

Next, the processor evaluates a tertiary dataset, such as vehicle telemetry data, to assess whether a tertiary interlock condition is met. For example, the system may extract a vehicle speed attribute and determine whether it falls below a predefined speed threshold (e.g., less than 3 mph), indicating that the vehicle is sufficiently close and slowing for pickup. When the tertiary threshold is satisfied alongside the primary and secondary thresholds, the processor transmits a control signal to activate an auxiliary component, such as an electric motor or hydrogen fuel cell, to pressurize the lift system or energize other subsystems before the cart is reached.

This three-tiered approach—requiring geolocation confirmation, object detection, and vehicle readiness—ensures that auxiliary systems are initiated only when all relevant load event conditions are met, thereby conserving energy while maximizing responsiveness.

While the methods 500-800 are illustrated in FIGS. 5-8 as progressing in a linear or serial fashion—wherein each condition is evaluated sequentially prior to evaluation of the next condition—it should be understood that this structure is exemplary and not limiting. In alternative embodiments, one or more of the condition-checking steps (e.g., steps 802, 806, and 808 of FIG. 8) may be continuously or concurrently evaluated in parallel by one or more processors or processing modules operating in a distributed or multi-threaded environment. For example, the system may simultaneously monitor sensor inputs corresponding to primary, secondary, and tertiary datasets, and, upon determining that all relevant threshold conditions are satisfied (whether simultaneously or within a predefined time window), immediately execute the final initiation step to transmit a control signal to the auxiliary component.

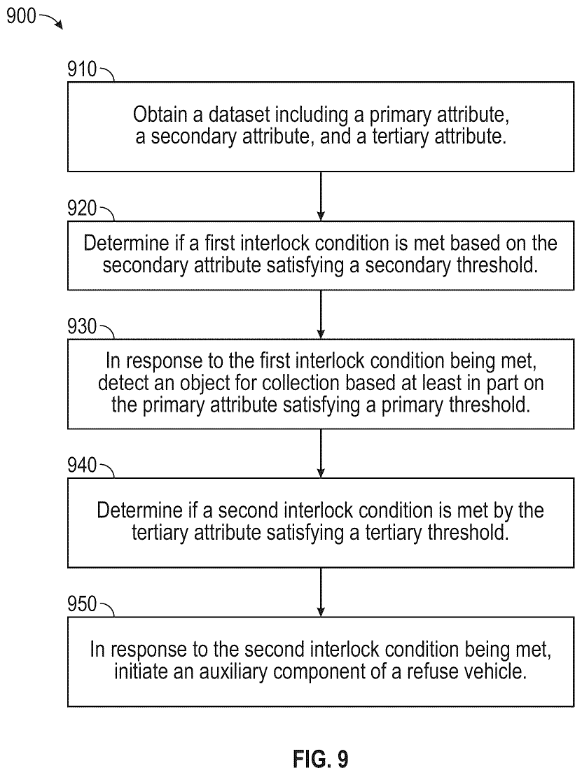

Turning now to FIG. 9, a method 900 for initiating an auxiliary component of a refuse vehicle is shown. The method 900 may be performed by one or more processors of the refuse vehicle and illustrates a control architecture in which multiple interlock conditions—each based on distinct vehicle, environmental, and object-related attributes—must be satisfied to initiate operation of an auxiliary component. The method may be implemented by processing circuitry executing computer-readable instructions stored on non-transitory media and corresponds to the initiation logic described in FIGS. 1-8.

At step 910, one or more processors obtain a dataset comprising a primary attribute, a secondary attribute, and a tertiary attribute, each originating from one or more sensors, subsystems, or onboard data repositories of the refuse vehicle. These attributes represent distinct classes of operational, navigational, and environmental data used to determine whether interlock conditions necessary for initiating an auxiliary component are satisfied.

The primary attribute may include perception data derived from a forward-facing sensor system, such as a camera, radar, LiDAR, or stereo vision module. This sensor system captures visual or spatial data from the vehicle's surrounding environment, which is then processed to extract features of interest—such as the presence, position, and classification of objects located along the collection route. In some embodiments, this attribute includes shape contours, size estimates, object proximity, or visual identifiers like barcodes, reflective tape, color codes, or route-specific markings on carts. The primary attribute is typically used to detect and confirm that an object suitable for collection (e.g., a refuse cart) is present within a predefined operational envelope.

The secondary attribute may be derived from navigation or geospatial positioning systems onboard the vehicle, such as GPS, GNSS, or inertial measurement units (IMUs). In this example, the secondary attribute includes the current geographic position of the vehicle, its heading, route adherence status, and collection zone identification. This attribute is compared against a predefined geofenced area or location-specific thresholds to verify whether the vehicle is within a permitted or expected region for performing the upcoming auxiliary action. In some embodiments, the secondary attribute may additionally include time-of-day, route schedule compliance, or historical pickup records to further inform condition satisfaction.

The tertiary attribute typically reflects a dynamic operational parameter of the vehicle itself, such as current speed, acceleration, steering angle, or system readiness. In one embodiment, the tertiary attribute is provided by a speed sensor or electronic control unit (ECU) and reflects whether the vehicle is decelerating or moving at a low enough velocity to safely engage in an auxiliary function like lifting a cart. In other embodiments, the tertiary attribute may include thermal conditions of a subsystem, battery voltage, or the status of previous load events (e.g., whether the last cart cycle is complete).

The dataset comprising these three attributes may be collected simultaneously or asynchronously. In some implementations, the system maintains rolling windows of historical data for each attribute and evaluates them in real time as part of a continuously running decision pipeline.

At step 920, the one or more processors determine whether a first interlock condition is met by evaluating the secondary attribute against a corresponding secondary threshold. The secondary attribute, which may reflect geolocation, route status, or regional compliance information, is used to assess whether the vehicle is operating within an authorized operational context for initiating an auxiliary function.

In one embodiment, the secondary attribute includes a global positioning system (GPS) coordinate or other localization data (e.g., GNSS, dead reckoning output, or location tags) that identifies the current position of the refuse vehicle relative to a predefined geofenced region. The secondary threshold may include spatial boundaries, such as latitudinal and longitudinal bounds of a scheduled pickup zone or dynamically generated service corridor. If the current location of the vehicle falls within this defined region, the attribute satisfies the threshold, and the interlock condition is met.

In other embodiments, the secondary attribute may include not just absolute position but also derived route indicators, such as whether the vehicle is actively traversing a planned collection route, approaching a scheduled stop, or operating within a permissible service window based on time or date. In such cases, the secondary threshold may include rules such as “must be on active route segment” or “must be within 15 meters of a known pickup location.” These parameters may be retrieved from memory, calculated dynamically, or received from a route management system in real time.

The evaluation at this step may be performed as a continuous monitoring operation, with one or more processors polling the secondary attribute at defined intervals or upon vehicle movement. If the secondary threshold is not satisfied, the first interlock condition is not met, and the system will not proceed to the next step. Instead, the system may either loop and re-evaluate after a delay or continue collecting updated secondary attributes until the condition is met.

In some implementations, the system may cache a confirmation flag once the secondary condition is met to reduce redundant computation and enable faster evaluation of subsequent conditions. This ensures that downstream steps (e.g., object detection or load preparation) are only performed when the refuse vehicle is operating within the appropriate spatial or temporal zone, thereby improving safety, reducing false positives, and conserving auxiliary power resources.

At step 930, in response to the first interlock condition being met, the one or more processors perform object detection based at least in part on the primary attribute satisfying a corresponding primary threshold. The primary attribute may include perception data obtained from one or more environmental sensors, such as cameras, LiDAR, radar, or infrared sensors, mounted on the refuse vehicle. This data is processed using one or more object recognition algorithms—such as convolutional neural networks, template matching techniques, or geometric feature extraction—to detect, classify, and evaluate objects within the vicinity of the vehicle.

For example, a forward-facing camera may capture image frames containing a potential collection object positioned near a curb. The system may extract relevant object characteristics from the image data, including dimensions (e.g., height, width, contour), orientation (e.g., facing angle relative to the vehicle), and spatial position relative to the vehicle's frame of reference. The processor may also evaluate color characteristics, text labels, reflective markings, or barcodes located on the object, such as a printed street address or service zone identifier.

The extracted features are compared to predefined criteria representing a primary threshold-a set of minimum or expected parameters that indicate a valid target for collection. For instance, the object may need to match a known cart profile in shape and size, be located within a designated lateral distance from the vehicle's approach path, and exhibit identifiable markings associated with an authorized pickup schedule. The primary threshold may be met if the system determines that the object is a collection-eligible refuse cart based on these criteria.

In some embodiments, the primary threshold may also require additional contextual validation, such as confirmation that the object is not obstructed, tipped over, or already collected. This may include evaluating object stability, occlusion metrics, or a time-since-last-encountered tag within the system's memory.

Once the object detection is complete and the primary attribute is determined to satisfy the primary threshold, the processor confirms that an object for collection has been detected and proceeds to evaluate additional conditions (e.g., a tertiary attribute). If the object does not meet the required threshold, the system may return to monitoring mode and continue scanning for new data.

At step 940, the one or more processors determine whether a second interlock condition is met based on the tertiary attribute satisfying a corresponding tertiary threshold. The tertiary attribute may represent one or more dynamic operational parameters of the refuse vehicle-such as speed, acceleration, hydraulic system status, energy availability, or actuator readiness-that indicate whether the vehicle is physically and operationally prepared to engage in a high-load auxiliary event, such as lifting a cart.

In one embodiment, the tertiary attribute includes a real-time speed reading from a wheel speed sensor or vehicle ECU. The processor compares this value against a predefined tertiary threshold, for example, a speed of less than 3 miles per hour. If the vehicle's current velocity satisfies this threshold, it is inferred that the vehicle is sufficiently decelerated or stationary to safely execute the auxiliary function. This condition reduces risk associated with premature or misaligned activation of the lift assembly while the vehicle is still in motion.

In other embodiments, the tertiary attribute may include estimated time-to-engagement, derived from both speed and distance to the detected object, to ensure that the auxiliary system is activated with enough lead time to build hydraulic pressure before the lift event occurs. The tertiary attribute may also include component-specific parameters, such as hydraulic pressure level, electrical subsystem voltage, or confirmation that a previous lift cycle has completed. These attributes are especially useful in refuse vehicles employing electric or hybrid powertrains where energy management is critical.

The tertiary attribute may be received from a distinct tertiary sensor or inferred from a combination of other vehicle telemetry signals. For instance, a controller area network (CAN) bus may supply multiple parameters from which the processor derives the tertiary attribute. This information is then compared to a stored or dynamic threshold value, which may be adjusted in real time based on vehicle mode, route profile, or weather conditions.

If the tertiary attribute satisfies the tertiary threshold, the second interlock condition is considered met. In response, the system proceeds to initiate the auxiliary component. If the tertiary threshold is not satisfied, the system may pause, cache the intermediate condition states, and resume monitoring until all interlock conditions are fully satisfied.

At step 950, in response to the secondary attribute satisfying the secondary threshold, the primary attribute satisfying the primary threshold, and/or the tertiary attribute satisfying the tertiary threshold, the one or more processors transmit a control signal to initiate an auxiliary component of the refuse vehicle. This control signal may be generated in accordance with a predefined actuation sequence, stored configuration profile, or real-time evaluation logic that governs when and how the auxiliary component is energized.

The auxiliary component may include one or more of: an electric motor, a hydraulic pump, an electric power take-off (E-PTO), or a secondary power source such as a hydrogen fuel cell, a high-voltage battery, or an onboard capacitor bank. In various embodiments, the auxiliary component forms part of a subsystem configured to provide localized or high-load functionality independent of the vehicle's primary drivetrain. For example, a hydraulic system powered by an

E-PTO may deliver pressurized fluid to a lift assembly, ejector, or cart grabber, and may require advance energization to meet the pressure demands of a cart lift event at the time of actuation.

The control signal transmitted by the one or more processors may include a digital command formatted according to a vehicle network protocol, such as CAN (Controller Area Network), LIN (Local Interconnect Network), or FlexRay. The signal may contain an activation command, a target operating mode (e.g., “engage at low-pressure idle” or “ramp to full pressure”), duration parameters, or safety constraints such as voltage and temperature limits. In some implementations, the control signal also includes handshaking or acknowledgment protocols to confirm receipt and successful activation by the receiving actuator or subsystem controller.

In an exemplary embodiment, the control signal initiates the E-PTO system, which routes electrical energy from the onboard battery pack to an electric motor. The motor begins rotation and drives a hydraulic pump that builds fluid pressure in the hydraulic lines leading to the lift assembly. By performing this operation in advance of reaching the detected cart, the system ensures that sufficient hydraulic pressure is available at the precise moment of engagement. This minimizes mechanical delay, avoids unnecessary idling of high-draw systems, and improves overall energy efficiency.

In additional embodiments, the auxiliary component may be coordinated with other subsystems, such as a power management controller, which allocates available electrical power between the primary propulsion system and the auxiliary load based on operational priority. If the auxiliary component includes a hydrogen fuel cell, the control signal may initiate airflow regulation, hydrogen valve opening, and power output stabilization to deliver electrical current to downstream components such as the E-PTO or lift actuator motor.

Although the method 900 is illustrated as progressing through serially executed steps, it should be understood that one or more of the condition-checking steps—such as the evaluation of the secondary attribute, primary attribute, and tertiary attribute—may be performed continuously in parallel. In such embodiments, the one or more processors may monitor attribute inputs asynchronously, and automatically initiate the auxiliary component once all interlock conditions are simultaneously satisfied.

It should be understood that the method 900 illustrated in FIG. 9 is exemplary and not limiting. The specific sequence of steps—namely, obtaining a dataset at step 910, evaluating interlock conditions based on secondary, primary, and tertiary attributes at steps 920, 930, and 940, and initiating an auxiliary component at step 950—may be modified, reordered, or selectively omitted depending on the implementation. In some embodiments, fewer than three interlock conditions may be used; for example, a simplified system may require only detection of a cart (primary attribute) to activate a lift motor, without evaluating vehicle location or speed. In other embodiments, additional thresholds may be incorporated to create more complex decision logic, such as verifying battery state-of-charge, hydraulic fluid temperature, or operator presence before proceeding with activation. Moreover, the steps may be executed in parallel, asynchronously, or as part of a rolling evaluation pipeline, where each attribute is continuously monitored and flagged once its associated condition is met. The method may also include fallback routines, retries, or confidence scoring based on historical pickup success. Accordingly, variations of the method that include more, fewer, or alternative steps remain within the scope and spirit of the present disclosure.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed using processing circuitry that includes a general-purpose single-or multi-chip processor, a digital signal processor (DSP), an application-specific integrated circuit (ASIC), a field-programmable gate array (FPGA), or other programmable logic device. In many embodiments, the processing circuitry is configured to execute computer-executable instructions retrieved from a computer-readable, non-transitory storage medium. This medium may include RAM, ROM, flash memory, magnetic drives, optical disks, or other forms of persistent or volatile memory.

The computer-readable, non-transitory storage medium may store data structures, software instructions, machine-learning models, or configuration parameters used by the processing circuitry to evaluate sensor input, control actuators, and perform decision logic consistent with the embodiments disclosed herein. In some cases, the processing circuitry includes specialized modules or coprocessors for sensor fusion, interlock condition evaluation, or predictive control. According to an exemplary embodiment, the computer-readable, non-transitory storage medium is communicably coupled to the processing circuitry via a data bus and is configured to provide real-time access to executable code segments, calibration values, and threshold parameters.

The present disclosure contemplates methods, systems, and program products embodied on any machine-readable medium or computer-readable, non-transitory storage medium for accomplishing the operations described herein. Embodiments may be implemented using conventional processors or special-purpose processing circuitry embedded within a vehicle's control architecture. These implementations may execute software logic or hardware-accelerated functions, such as sensor signal parsing or threshold evaluation, as part of an interlock-driven control strategy. Such computer-readable, non-transitory storage media may include combinations of persistent and non-persistent memory and may support concurrent access by multiple processors within distributed or modular control systems.

Although the figures and descriptions may illustrate a particular order of steps, it should be understood that one or more steps may be omitted, reordered, or executed in parallel. In many implementations, processing circuitry may continuously evaluate attributes in real time using event-driven or interrupt-based polling strategies. Execution of software instructions stored on the computer-readable, non-transitory storage medium may involve multi-threaded, distributed, or asynchronous task scheduling depending on hardware capabilities. The disclosed methods may thus be implemented in firmware, operating systems, middleware, or application-specific routines.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sensor placement, data processing strategies, or actuator coordination) without materially departing from the novel teachings and advantages of the subject matter recited. Accordingly, the use of processing circuitry and one or more computer-readable, non-transitory storage media to execute the functions described herein is not limited to any single architectural model. Variations and substitutions involving different combinations of hardware and software are fully within the scope of the present disclosure.

What is claimed is:

1. A refuse vehicle comprising:
an auxiliary component;
a sensor;
one or more processors; and
a computer-readable, non-transitory storage medium comprising instructions that, when executed by the one or more processors, cause the one or more processors to execute a method comprising:
obtaining a dataset from the sensor, the dataset including a primary attribute;
detecting an object for collection based on the primary attribute satisfying a primary threshold; and
in response at least in part to detecting the object for collection based on the primary attribute satisfying the primary threshold, initiating the auxiliary component.

2. The refuse vehicle of claim 1 wherein the auxiliary component is one of a hydraulic pump, an electric motor, an E-PTO, and a fuel cell.

3. The refuse vehicle of claim 1, wherein the object is a refuse cart.

4. The refuse vehicle of claim 3, wherein the primary attribute is one of a position of the object, an orientation of the object, a color of the object, a shape of the object, a distance to the object from the refuse vehicle, a confidence value of a presence of the object, and a weight of the object.

5. The refuse vehicle of claim 1, wherein the auxiliary component is coupled to one of a lift assembly, an ejector, a refuse collector, a refuse cart grabber, a refuse compactor, a vehicle access device, a vehicle door, and a hopper door.

6. The refuse vehicle of claim 1, the method further comprising:
receiving a secondary dataset, the secondary dataset including a secondary attribute;
determining an interlock condition is satisfied based on the secondary attribute satisfying a secondary threshold; and
in response at least in part to the interlock condition being satisfied and detecting the object for collection based on the primary attribute satisfying the primary threshold, initiating the auxiliary component.

7. The refuse vehicle of claim 1, the method further comprising:
receiving a secondary dataset, the secondary dataset including a secondary attribute;
determining an interlock condition is satisfied based on the secondary attribute satisfying a secondary threshold; and
in response at least in part to the interlock condition being satisfied by the secondary attribute satisfying the secondary threshold, detecting the object for collection based on the primary attribute satisfying the primary threshold; and
in response to detecting the object for collection based on the primary attribute satisfying the primary threshold, initiating the auxiliary component.

8. The refuse vehicle of claim 7, the method further comprising:
receiving a tertiary dataset, the tertiary dataset including a tertiary attribute;
in response at least in part to detecting the object for collection based on the primary attribute satisfying the primary threshold, determining if the tertiary attribute satisfies a tertiary threshold; and
in response at least in part to the tertiary attribute satisfying the tertiary threshold and detecting the object for collection based on the primary attribute satisfying the primary threshold, initiating the auxiliary component.

9. The refuse vehicle of claim 6, wherein the secondary attribute corresponds to at least one of a power source attribute, a hydraulic system attribute, a high voltage component attribute, a vehicle attribute, an operator attribute, an object attribute, a weather attribute, an obstacle detection, a hopper capacity, a navigation route, a current location, and a user input.

10. A refuse vehicle comprising:
an auxiliary component;
a sensor;
one or more processors; and
a computer-readable, non-transitory storage medium comprising instructions that, when executed by the one or more processors, cause the one or more processors to execute a method comprising:
obtaining a dataset including a primary attribute, a secondary attribute, and a tertiary attribute;
determining if a first interlock condition is met based on the secondary attribute satisfying a secondary threshold;
in response at least in part to the first interlock condition being met, detecting an object for collection based at least in part on the primary attribute satisfying a primary threshold;
determining if a second interlock condition is met by the tertiary attribute satisfying a tertiary threshold; and
in response at least in part to the second interlock condition being met, initiating the auxiliary component.

11. The refuse vehicle of claim 10 wherein the auxiliary component is one of a hydraulic pump, an electric motor, an E-PTO, and a fuel cell.

12. The refuse vehicle of claim 10, wherein the object is a refuse cart.

13. The refuse vehicle of claim 12, wherein the primary attribute is one of a position of the object, an orientation of the object, a color of the object, a shape of the object, a distance to the object from the refuse vehicle, a confidence value of a presence of the object, and a weight of the object.

14. The refuse vehicle of claim 10, wherein the auxiliary component is coupled to one of a lift assembly, an ejector, a refuse collector, a refuse cart grabber, a refuse compactor, a vehicle access device, a vehicle door, and a hopper door.

15. The refuse vehicle of claim 10, wherein the secondary attribute corresponds to at least one of a power source attribute, a hydraulic system attribute, a high voltage component attribute, a vehicle attribute, an operator attribute, an object attribute, a weather attribute, an obstacle detection, a hopper capacity, a navigation route, a current location, and a user input.

16. A computer-readable, non-transitory storage medium comprising instructions that when executed by one or more processors, cause the one or more processors to execute a method comprising:
obtaining a dataset including a primary attribute, a secondary attribute, and a tertiary attribute;
determining if a first interlock condition is met based on the secondary attribute satisfying a secondary threshold;
in response at least in part to the first interlock condition being met, detecting an object for collection based at least in part on the primary attribute satisfying a primary threshold;
determining if a second interlock condition is met by the tertiary attribute satisfying a tertiary threshold; and
in response at least in part to the second interlock condition being met, initiating an auxiliary component of a refuse vehicle.

17. The computer-readable, non-transitory storage medium of claim 16 wherein the auxiliary component is one of a hydraulic pump, an electric motor, an E-PTO, and a fuel cell.

18. The computer-readable, non-transitory storage medium of claim 16, wherein the primary attribute is one of a position of the object, an orientation of the object, a color of the object, a shape of the object, a distance to the object from the refuse vehicle, a confidence value of a presence of the object, and a weight of the object.

19. The computer-readable, non-transitory storage medium of claim 16, wherein the auxiliary component is coupled to one of a lift assembly, an ejector, a refuse collector, a refuse cart grabber, a refuse compactor, a vehicle access device, a vehicle door, and a hopper door.

20. The computer-readable, non-transitory storage medium of claim 16, wherein the secondary attribute corresponds to at least one of a power source attribute, a hydraulic system attribute, a high voltage component attribute, a vehicle attribute, an operator attribute, an object attribute, a weather attribute, an obstacle detection, a hopper capacity, a navigation route, a current location, and a user input.
